(19) United States
(12) Patent Application Publication
(10) Pub. No.: US 2013/0002050 A1
(43) Pub. Date: Jan. 3, 2013

(54) ACTUATING DEVICE FOR A ROBOT DRIVER

(75) Inventors: Anton Knestel, Hopferbach (DE); Markus Knestel, Hopferbach (DE); Thomas Specker, Muhlheim (DE)

(73) Assignee: MAHA-AIP GMBH & CO. KG, Haldenwang (DE)

(21) Appl. No.: 13/511,440

(22) PCT Filed: Dec. 10, 2010
(86) PCT No.: PCT/EP2010/007535

§ 371 Date: Sep. 7, 2012

(30) Foreign Application Priority Data
Dec. 11, 2009 (DE) 10 2009 054 575.1

(51) Int. Cl. H02K 41/02

(52) U.S. Cl. 310/12.04

(57) ABSTRACT

An actuating device for a robot driver that reduces the effort involved for setting or learning of the actuating means. In addition, the effort for determining the pedal force can be reduced. The actuating device comprises at least one actuating means, which has at least one control rod comprising an actuator region and a contact element, wherein the contact element can be caused to connect to a pedal and the control rod in the actuator region is a rotationally symmetrical component which is slidably received in an actuator housing in the actuator region. In the actuator region the control rod contains a first element, and the actuator housing has a second element which is provided in an outer circumferential region of the first element, wherein the first element and the second element form an electromagnet force-generating means for moving the control rod.

The present invention relates to an actuating device for a robot driver that reduces the effort involved for setting or learning of the actuating means. Furthermore, the effort for determining the pedal force can be reduced.

It is known that on roller type test stands not only humans are used for implementing drive cycles and/or controlling functions but that robot drivers are also used which in comparison to a human driver offer the advantage of an accurately controllable program run and relatively low dispersion of the target values to be approached.

However, one problem in robot drivers is the process of adapting the maximum displacement path of the actuators for actuating the pedals to the respective pedal configuration, wherein the distance between the zero position of the pedal and its pressed-down position respectively changes in dependence of the motor vehicle to be tested. Therefore, it has so far been required that the actuator must be taught or trained to its maximum displacement path during the respective test cycle wherein the actuator first has to be approached to the zero position of the pedal and subsequently be connected to the latter.

After that, the actuator must be moved step by step in an actuating manner for such a long time until the pressed-down position of the pedal has been reached, which is time-consuming. Then, in operation the control of the actuator will provide for the actuator to be moved between the learnt zero position and the above-described learnt pressed-down position of the pedal.

DE 43 14 731 A1 discloses a device and a method for controlling a robot driver in which force measuring sensors are mounted to the front ends of the actuators, which can continuously obtain the actuating force in any position of the pedal. However, it is a drawback of this device that considerable effort is necessary regarding the associated measuring and evaluating technique.

It is an object of the present invention to provide an actuating device for a robot driver in which pedal force measurement is simplified. It is another object of the present invention to enable simple and fast setting or learning of the actuating means for various pedal configurations.

This object is achieved according to the invention by the subject-matters of the independent claim. Advantageous developments and preferred embodiments of the invention are stated in the subclaims.

According to the invention, an actuating device for a robot driver is provided which has at least one actuating means, the latter comprising at least one control rod having an actuator region and a contact element wherein the contact element can be caused to connect to a pedal and the control rod in the actuator region is a rotationally symmetrical component, which is slidably received in an actuator housing in the actuator region. Furthermore, the control rod in the actuator region contains a first element and the actuator housing has a second element, which is provided in an outer circumferential region of the first element, wherein the first element and the second element form an electromagnetic force-generating means for moving the control rod.

The present structure of the actuating device offers the advantage that the use of (force) measuring sensors for determining the actuating force of the pedal can be omitted both for setting the actuating means when connecting it to the pedal and the measurement thereof in use because the force introduced into the control rod by the electromagnetic force-generating means is, for example, proportional to the electric current for the second element and thus known if the electric current is known. Thus, the costs for the actuating device can be reduced.

Another advantage of the present actuating device results with regard to the setting and/or learning of the actuating means as compared to the above-described procedure according to the prior art. In order to obtain the position of the control rod in the zero position of the pedal and for connecting the control rod to the pedal, first the electromagnetic force-generating means is deactivated in the present actuating device. Then, the control rod is manually guided in the direction of the pedal until the contact element, which depending on the pedal to be actuated may also be a connecting element, of the control rod can be caused to form a preferably positive fitting and/or a force-fitting connection with the pedal, wherein only little force is required for shifting the control rod.

The end position of the control rod for the pressed-down pedal is also obtained when an electromagnetic force-generating means is deactivated, wherein for this purpose the control rod is moved until the end position of the pedal is reached. Subsequently, the path measurement of the control rod stores the position thereof as an end position in a connected computer.

Moreover, the present actuating device for a robot driver offers the advantage that due to its structure and the minimizing of the moved parts a particularly silent and dynamic actuating device for a robot driver is provided which is also suitable for use on a driving noise test stand.

A gap may be provided between the first element and the second element of the electromagnetic force-generating means wherein the size of the gap may be selected such that a tilting or twisting of the actuator region of the control rod inside the actuator housing is prevented while at the same time a guidance of the actuator region that runs as smoothly, that is, friction-free, as possible is realized in the second element. The width of the gap between the first element and the second element of the electromagnetic force-generating means may be substantially constant in the longitudinal direction of the second element. Alternatively, the gap width between the first element and the second element of the electromagnetic force-generating means may also decrease and/or increase in the longitudinal direction of the second element.

Furthermore, in operation the actuator region may protrude at both ends of the actuator housing in any position of the control rod. Thus, the length of the displacement path for the control rod in operation is merely limited by the length of the first element in the control rod while at the same time it is possible to move the control rod in opposite directions.

Moreover, the actuator region may extend in the longitudinal direction through the actuator housing in any position of the control rod.

Furthermore, the first element in the electromagnetic force-generating means may be at least one coil and the second element may have at least one magnet.

In the following a coil is to be understood as a component which on the one hand has a predetermined number of windings and on the other hand is suitable for generating or detecting a magnetic field. A coil may consist of at least one winding of a conductor made of e.g. wire, enameled copper wire or a high frequency stranded wire. The coil may be wound on a bobbin. Furthermore, the coil may be provided with a magnetizable core. The electromagnetic characteristics of a coil are determined in particular by the winding arrangement, its diameter, the winding and core materials, which can be stated quantitatively in particular by means of the value of the inductance thereof.

Moreover, the second element and/or the coil may be a rotationally symmetrical component. Alternatively, the second element and/or the coil may also have a non-symmetrical design.

The magnets may e.g. be permanent magnet that may consist of metal alloys that can contain, for example, iron, nickel and aluminum with additives of cobalt, manganese and copper. However, the permanent magnets may also consist of a ceramic material, such as barium or strontium hexaferrite. Alternatively, the magnets may also be solenoids having, for example, one or two current-carrying coils with a core made of a magnetically soft material, in particular soft iron.

In the present actuating device for a robot driver, adjacent magnets may each have an opposite magnetic orientation.

Furthermore, in the actuating device, a plurality of magnets may be arranged inside the actuator region. Moreover, the magnets may each have a cylindrical and/or disc-shaped design. Due to the rotationally symmetrical design of the magnets in the actuator region, the former may be introduced into the control rod by using a bore. In the present actuating device, the magnets in the actuator region may also be flush with the outer circumferential surface of the actuator region so that the actuator region is completely formed by the magnets. Alternatively, the magnets of the actuator region may be formed in ring-shape wherein the former will then be received with their inner circumferential surface in the outer circumferential region of the actuator region.

In a present actuating device for a robot driver the electric current may be substantially proportional to the force of the control rod introduced into the pedal because of the at least one coil. Proportional may be understood to be a substantially linear connection between the electric current for a coil and the force of the control rod into the pedal resulting therefrom. Alternatively, it may also be understood to be a non-linear connection, wherein the non-linearity in the control of the electric current for the coil may, for example, be taken into consideration by using a characteristic so that the desired actuating force may be provided at the pedal.

Furthermore, in the present actuating device the control rod may be rotatable with little force in a current-less state of the coil and the second element, respectively. This is an advantage particularly as regards the connecting of the contact or connecting element of the control rod to the pedal when the actuating device is set because after switch-off of the electromagnetic force-generating means the contact or connecting element of the control rod can be pivoted with little force and subsequently slid manually into the region below the pedal, wherein only one further pivoting action in the direction of the pedal is required for connecting the contact or connecting element to the pedal. The exact setting of the position of the contact or connecting element to the pedal is finally performed by sliding the control rod.

In a present actuating device for a robot driver the control rod can be movable to its initial position by means of the reset force of the pedal when the coil is in a current-less condition. This offers the advantage that thus after the end of the drive cycle to be tested the control rod is automatically guided into the zero position of the pedal due to the switch-off of the electromagnetic force-generating means so that when the drive cycle is repeated a reset of the control rod to the initial position may be omitted.

Furthermore, in the present actuating device magnetic field sensors may be provided which scan the magnets in the actuator region with a phase offset of substantially 90° so that thus the position of the control rod can be determined by means of interpolation. Thereby, the magnetic sensors may be used to detect the position of the control rod, wherein the interpolation of the sine and cosine values of the measuring values of the magnetic field sensors provides a high-resolution path signal.

Furthermore, in a present actuating device for a robot driver the length of the actuator housing may substantially correspond to the length of the electromagnetic force-generating means.

Advantageous developments and further details of the present invention will be described in the following by using various embodiments with reference to schematic drawings.

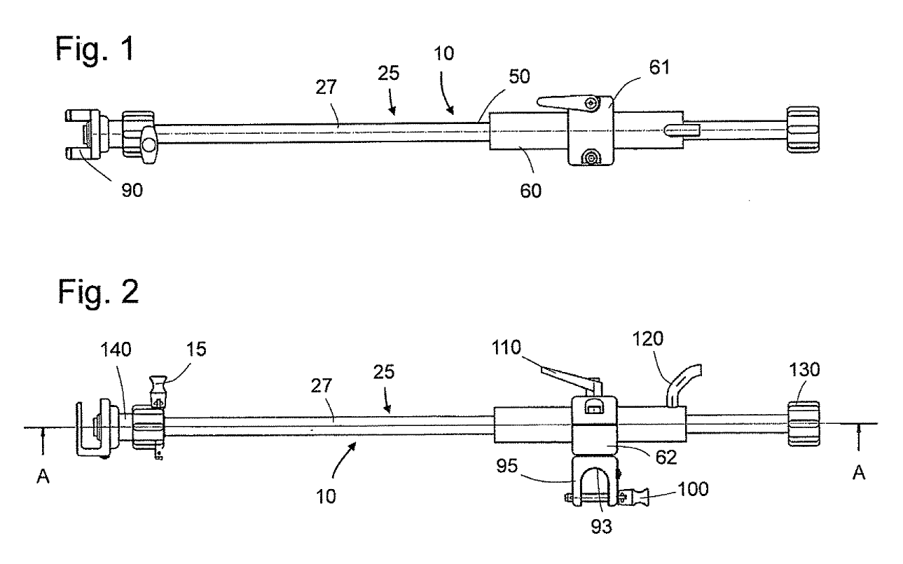

FIG. 1 shows a top view of an actuating means for a present actuating device,

FIG. 2 shows a side view of the actuating means according to FIG. 1,

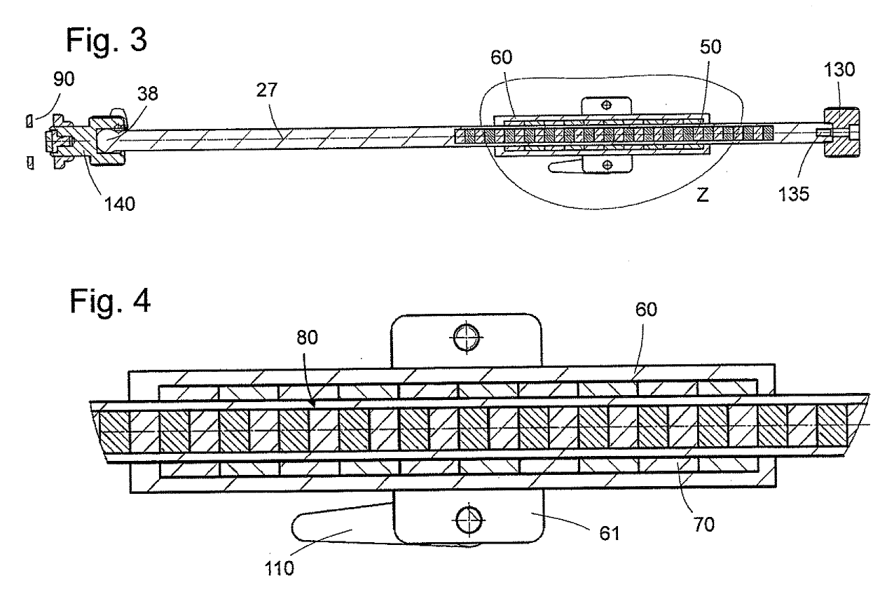

FIG. 3 shows a lateral sectional view along section line A-A of the actuating means according to FIG. 2,

FIG. 4 shows a detailed view of the range Z of the actuating means according to FIG. 3,

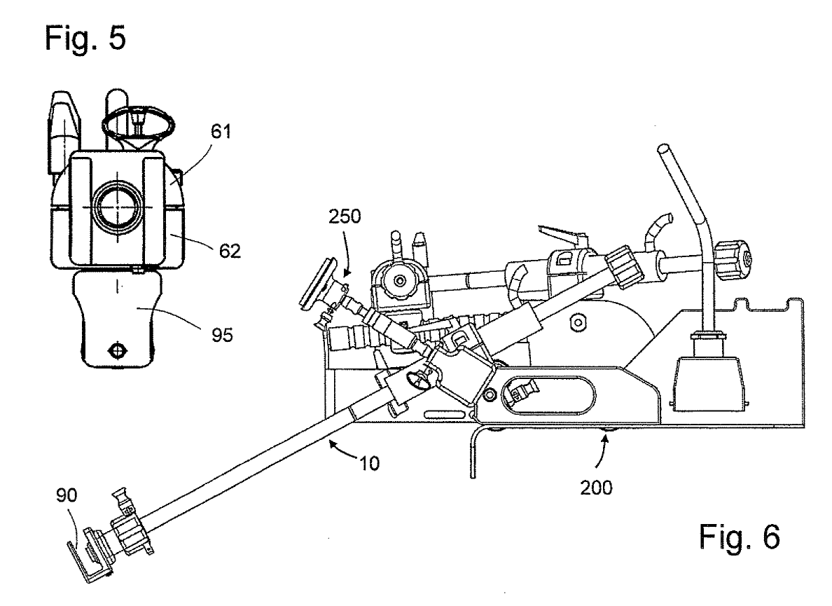

FIG. 5 shows a front view of the actuating means according to FIG. 1,

FIG. 6 shows a side view of an actuating device including the actuating means according to FIG. 1,

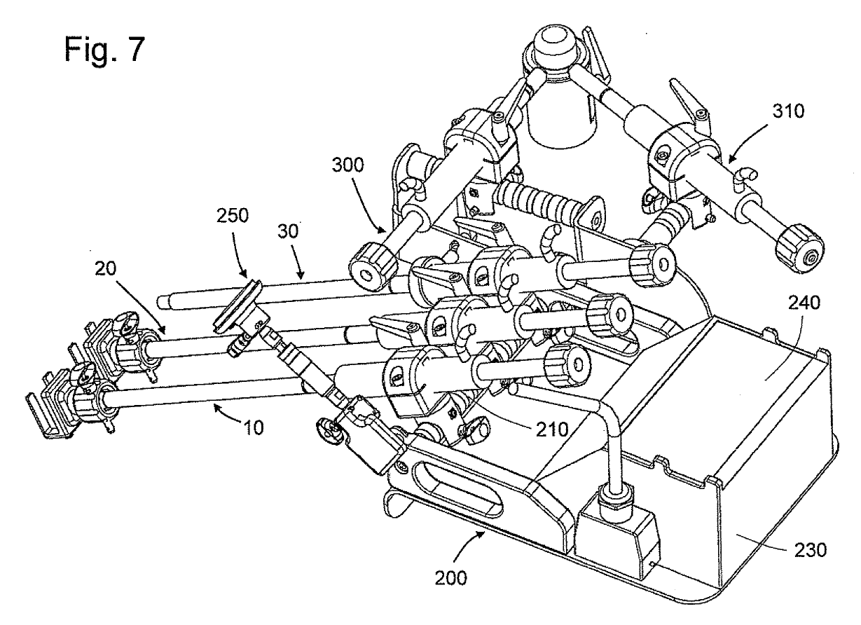

FIG. 7 shows a perspective view of the actuating device according to FIG. 6,

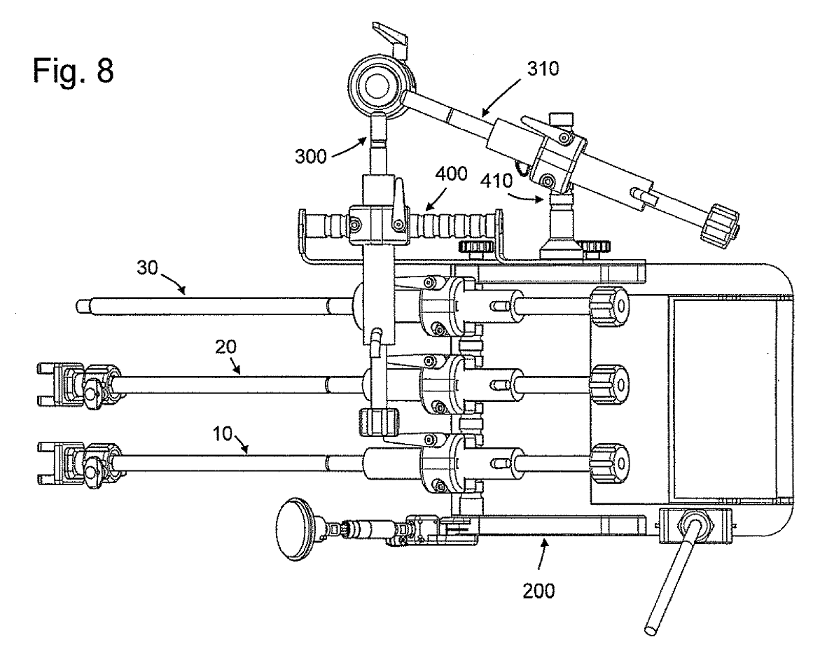

FIG. 8 shows a top view of the actuating device according to FIG. 6,

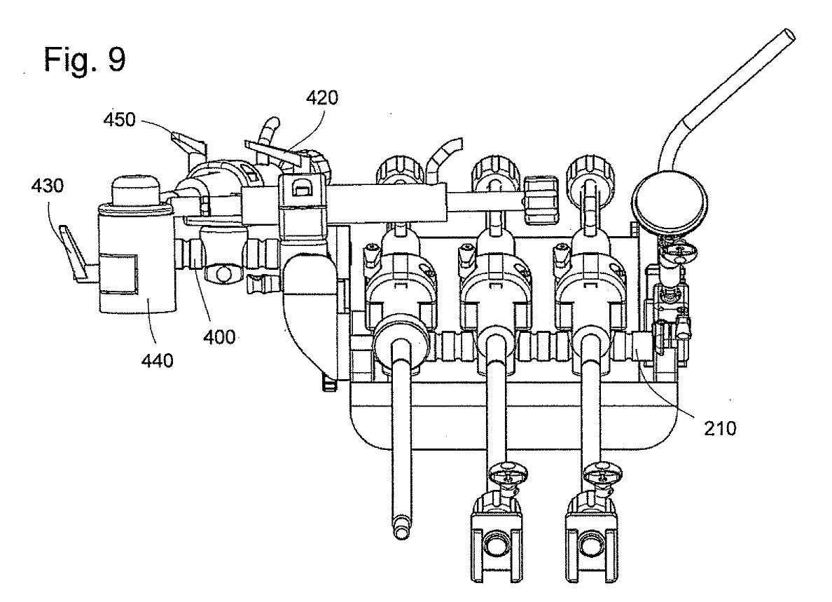

FIG. 9 shows a front view of the actuating device according to FIG. 6,

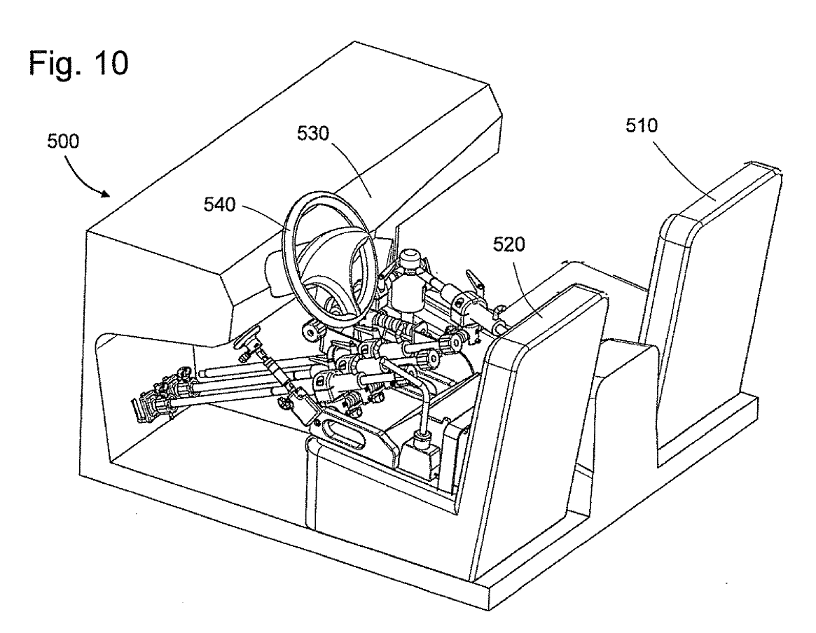

FIG. 10 shows a perspective view of the actuating device according to FIG. 6 in a vehicle,

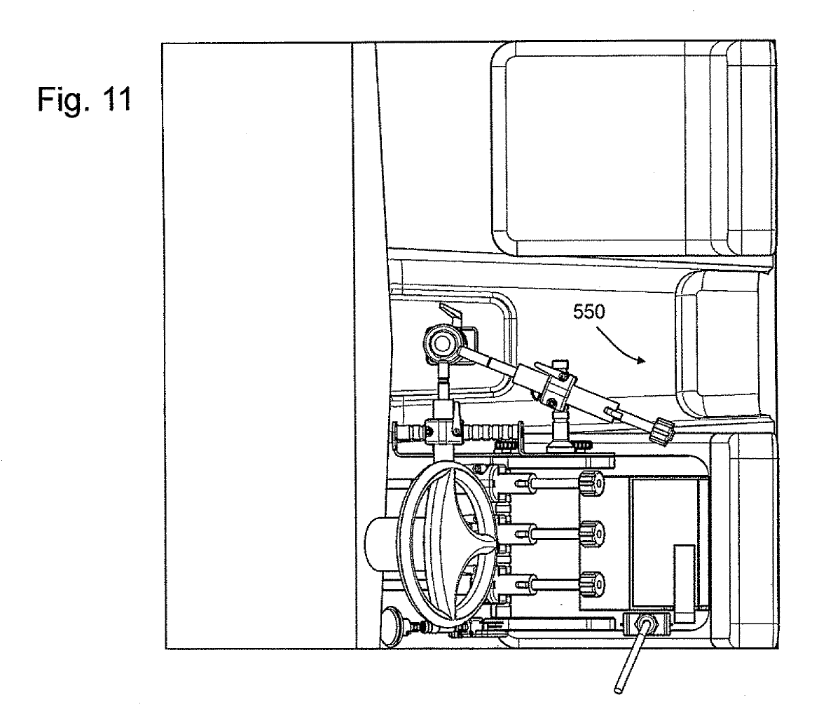

FIG. 11 shows a top view of the vehicle including an actuating device according to FIG. 10,

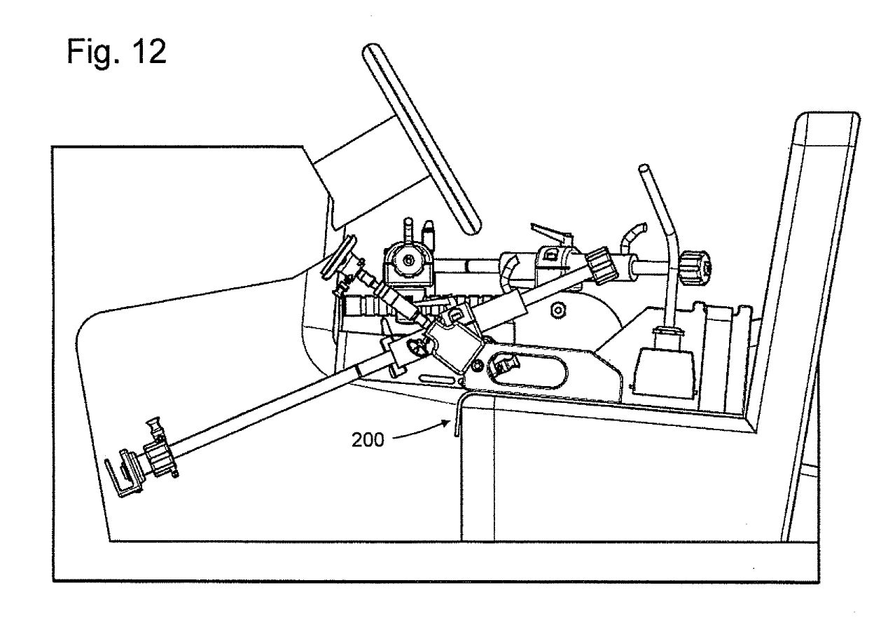

FIG. 12 shows a view from the side of the vehicle according to FIG. 10,

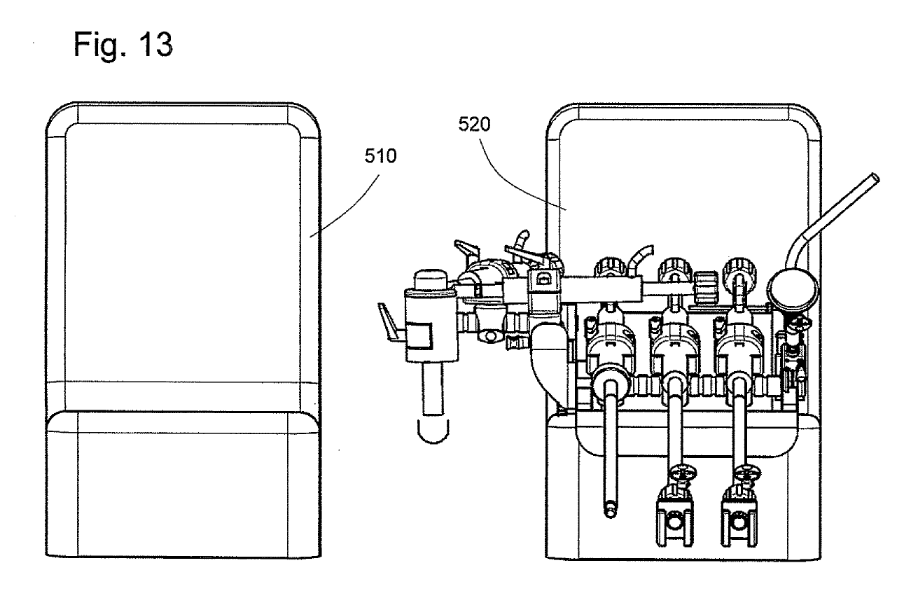

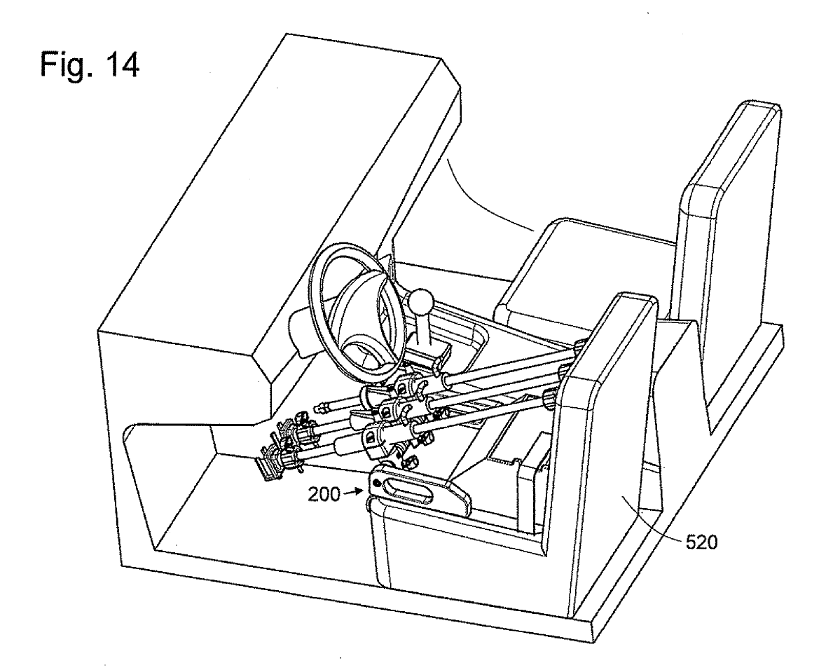

FIG. 13 shows a partial sectional view of the vehicle according to FIG. 10, and

FIG. 14 shows a perspective view of the vehicle with retracted control rods for the actuating device according to FIG. 10.

Referring to FIGS. 1-5, an actuating means 10 for a present actuating device for a robot driver will now be described. Here, the essential components of the actuating means 10 form a control rod 25 which is received in an actuator housing 60 and slidably supported therein, as well as an electromagnetic force-generating means formed by a coil 70 (as a first element) and at least one magnet 80 (as a second element). Preferably, a plurality of magnets 80 is used. The control rod 25 has an actuator range 50 and a connecting portion 27 including a contact or connecting element 90, the connecting element 90 being disposed at a longitudinal end of the connecting portion 27. The plurality of magnets 80 is disposed inside the actuator region 50 of the control rod 25.

In the area of the free longitudinal end of the actuator region 50 a stop 130 is formed which prevents the control rod 25 from slipping out of the actuator housing 60. The stop 130 is connected to the control rod 25 by means of a screw 135.

The connecting element 90 has a U-shaped design, the inner range of the connecting element 90 being connected to a pedal (not shown) of a vehicle (not shown) so that during the operation of the actuating device the actuating means 10 can apply force to the pedal by using the control rod 25 and thus operate it. The connecting element 90 is connecting to a coupling sleeve 140.

At the longitudinal end which is opposite the connection of the coupling sleeve 140 to the connecting element 90, the coupling sleeve 140 has a shape of the type of a hexagonal recess wherein in the interior thereof a connecting head 38 is received that is formed at the free longitudinal end of the connecting portion 27 and designed such that it is possible to transfer a torque between the connecting portion 27 and the coupling sleeve 140. Thus, the connecting element 90 can follow the regulating moves of the control rod 25. A desired position of the connecting element 90 between the coupling sleeve 140 and the control rod 25 can be fixed by using a pedal clamping lever 15.

For the electrical and control supply of the coil 70 and of magnetic field sensors (not shown) in the actuator housing 60 in order to determine the position of the control rod 25 the actuator housing 60 is connected to a cable line 120 which on the inside has power supply cables (not shown) that are connected to a voltage source (not shown). Additionally, the cable line 120 has at least one data cable (not shown) on the inside that is connected to a control computer (not shown).

The actuator housing 60 has a substantially hollow cylindrical design wherein seals (not shown) may be provided at the longitudinal ends of the actuator housing 60 that can protect the interior of the actuator housing 60 against dirt being introduced from the actuator region 50 of the slidable control rod 25. In the middle region of its longitudinal ends the actuator housing 60 has a respective bore whereby the actuator region 50 is inserted in and/or passed through the actuator housing 60. The diameter of the bore is greater than the diameter of the actuator region 50 which is why there is a gap between the two components.

The actuator housing 60 is received by an upper clamp jaw 61 and a lower clamp jaw 62, each having a bearing portion (not shown) formed in the type of a bearing shell and respectively serving for connection to the actuator housing 60. Thus, the actuator housing 60 is supported so as to be rotatable and slidable in the longitudinal direction of the actuator housing 60. For fixing the actuator housing 60 with the clamp jaws 61, 62, a clamping lever 110 is provided that can clamp the two clamp jaws 61, 62 with the actuator housing 60 and release the connection for moving the actuator housing 60, respectively. The lower clamp jaw 62 is connected to a pipe connector 95 that serves to connect the actuating means 10 to a receiving pipe (not shown), the pipe connector 95 having a pipe receiving portion 93 extending in a transverse direction to the actuator housing 60. For fixing the actuating means 10 to the receiving pipe the pipe connector 95 has a bore In the end area of its receiving leg which bore receives a fixing pin 100 that provides for clamping the receiving pipe with the pipe receiving portion 93 of the pipe connector 95 by twisting.

Inside the actuator housing 60 a coil 70 which consists of a plurality of windings is disposed in the range of the inner circumferential wall. The coil 70 encloses the outer circumferential portion of the actuator region 50 of the control rod 25, a gap being formed between the two components. The gap between the outer circumferential portion of the actuator region 50 and the coil 70 is rotationally symmetrical. The coil 70 also has a rotationally symmetrical design.

In operation, an electric current flows through the coil 70 and generates a magnetic field around the coil 70. The magnetic field of the coil 70 overlays the magnetic field of the magnet(s) 80 of the actuator region 50 of the control rod 25 whereby a resulting force is applied to the control rod 25 the magnitude of which is substantially proportional to the current through the coil 70. Moreover, this resulting force provides a movement of the control rod 25 relative to the fixed actuator housing 60, the direction of the relative movement depending on the current passage direction in the coil 70.

The plurality of magnets 80 inside the actuator region 50 each have a cylindrical design, their diameter being smaller than the diameter of the actuator region 50. in addition, adjacent magnets respectively have an opposite magnetic orientation. The length of the actuator region 50 is determined by the entire length of the respective adjacent magnets 80.

Referring to FIGS. 6-9, a present actuating device for a robot driver will now be described, wherein a plurality of actuating means 10, 20, 30, 300, 310 is provided for actuating different pedals and components, respectively. The actuating means 10 and 20 each have a connecting element 90 which serves to connect the respective control rod 25 of the actuating means to a pedal (not shown) whereas the actuating means 30 has no corresponding connecting element. Thus, the actuating element 10 serves to actuate the coupling in a vehicle (not shown) while the actuating means 20 disposed adjacent thereto serves to actuate the pedal for the brake. The actuating means 30 serves to actuate the speed pedal. The actuating means 10, 20, 30 are connected to an indented receiving pipe 210 whereby they are disposed adjacently in a spaced-apart manner. The distance between two actuating means depends on the distance between two associated adjacent pedals.

Furthermore, the actuating device has two actuating means 300, 310 for actuating a transmission shift lever 440, the installation site of the actuating means 300, 310 being adjustable for adaptation to the respective position of the shift lever (not shown) by using a respective indented transmission receiving pipe 400 and 410, respectively. The actuating means 300, 310 each have a clamping lever 420, 450 that ensure a rotation-preventing fixation of the actuating means 300, 310.

The indented receiving pipe 210 is connected to a seat construction 200 which is used in a vehicle to be tested instead of a commercially available seat. In the area which is usually taken by the driver of the vehicle the seat construction 200 has a control computer housing 230 which accommodates the control computer 240 (not shown) inside. The control computer 240 provides all information and/or commands for actuating the used actuating means during a drive cycle and a function test of the vehicle, respectively.

A supporting element 250 is connected to the seat construction 200, the free end of the former being connected to the dashboard (not shown) of the vehicle.

Referring to FIGS. 10-14, a present actuating device for a vehicle 500 will now be described wherein the components of the interior of the vehicle 500 are only schematically shown. A steering wheel 540 is mounted on a dashboard 530 of the vehicle 500. The seat construction 200 is attached to a seat 520 on the driver's side of the vehicle 500. Adjacent to the driver's seat 520, the front passenger seat 510 is disposed, the two seats being separated from each other by a central console 550.

FIG. 14 shows a perspective view of a cut-out of the interior of the vehicle 500 wherein the present actuating device is in an insertion and/or removal configuration. Before the actuating device is inserted into the vehicle 500, the control rods of the individual actuating means are each slid to the rear and top (in the direction of the seat) so that after the insertion of the seat construction 200 onto the driver's seat 520 they are no longer within the range of the pedal (not shown), which considerably simplifies the insertion of the seat construction 200.

The embodiments as shown are to be interpreted merely as illustrative and not limiting, Numerous modifications may be made to them without departing from the scope of protection of the claims.

1. An actuating device for a robot driver, having at least one actuating means, comprising:
at least one control rod comprising an actuator region and a contact element, wherein the contact element can be caused to connect to a pedal and the control rod in the actuator region is a rotationally symmetrical component, which is slidably received in an actuator housing in the actuator region; and
wherein in the actuator region the control rod contains a first clement, and the actuator housing has a second element which is provided in an outer circumferential region of the first element, the first element and the second element forming an electromagnet force-generating means for moving the control rod.

2. The actuating device for a robot driver according to claim 1, wherein the actuator region protrudes at both ends of the actuator housing in any position of the control rod.

3. The actuating device for a robot driver according to claim 1, wherein the actuator region extends in the longitudinal direction through the actuator housing in any position of the control rod.

4. The actuating device for a robot driver according to claim 3, wherein the first element in the force-generating means is at least one coil and the second element has at least one magnet.

5. The actuating device for a robot driver according to claim 4, wherein adjoining magnets each have an opposite magnetic orientation.

6. The actuating device for a robot driver according to claim 5, wherein a plurality of magnets is disposed inside the actuator region and the magnets each have a cylindrical and/or disc-shaped design.

7. The actuating device for a robot driver according to claim 4, wherein the current through the at least one coil is substantially proportional to the force of the control rod introduced into the pedal.

8. The actuating device for a robot driver according to claim 4, wherein the control rod is rotatable with little force when the coil is in a current-less state.

9. The actuating device for a robot driver according to claim 4, wherein the control rod can be moved into its initial position by using the reset force of the pedal when the coil is in a current-less state.

10. The actuating device for a robot driver according to claim 4, wherein magnetic field sensors are provided that scan the magnets in the actuator region with a phase shift of substantially 90° so that thereby the position of the control rod can be determined by using interpolation.
